(19) United States
(12) Patent Application Publication
(10) Pub. No.: US 2006/0145698 A1
(43) Pub. Date: Jul. 6, 2006

(54) Apparatus for use in nmr system

(76) Inventor: Adrian P Griffin, Torquay (DE)

Correspondence Address: STAAS & HALSEY LLP, SUITE 700, 1201 NEW YORK AVENUE, N.W., WASHINGTON, DC, 20005, US

(21) Appl. No.: 10/532,761

(22) PCT Filed: Nov. 5, 2003
(86) PCT No.: PCT/GB03/04771

§ 371 Date: Jan. 26, 2006

(30) Foreign Application Priority Data
Nov. 6, 2002 (GB) 0225898.6

(51) Int. Cl. G01V 3/00

(52) U.S. Cl. 324/321; 324/318

(57) ABSTRACT

Apparatus for use in a NMR system comprises a magnetic field generator (1) surrounding a bore (3), for generating a magnetic field in a working volume (9) located in the bore. A sample support (11) can be removably inserted into a first end of the bore (3) so as to locate a sample in the working region (9). A probe (4) carrying RF generating and receiving coils (6-8) can be removably inserted into the other, second end of the bore (3) so as to locate the RF coils adjacent the working volume. A set of shim coils (19) located in the bore (3) about the working volume (9) cooperate with the magnetic field generator (1) to create a magnetic field in the working volume of sufficient uniformity to perform a NMR experiment on a sample. The RF receiving and generating coils (6-8) are located in a reduced diameter section of the probe (4) at its leading end. At least some of the shim coils (19) are located on a support (23) surrounding the reduced diameter section of the probe.

The invention relates to apparatus for use in a NMR system, the apparatus comprising a magnetic field generator surrounding a bore, for generating a magnetic field in a working volume located in the bore; a sample support which can be removably inserted into a first end of the bore so as to locate a sample in the working region; a probe carrying RF generating and receiving coils and which can be removably inserted into the other, second end of the bore so as to locate the RF coils adjacent the working volume; and a set of shim coils located in the bore about the working volume and which cooperate with the magnetic field generator to create a magnetic field in the working volume of sufficient uniformity to perform a NMR experiment on a sample. Such apparatus is hereinafter referred to as of the kind described.

Apparatus of the kind described is manufactured and sold by Oxford Instruments Superconductivity Limited.

There is a continuing need to design apparatus of the kind described with increasingly higher magnetic field strengths and this requires significant additional space to accommodate windings of the magnetic field generator which is undesirable, increased cost because of the extra conductor required and more complex quench energy management.

In accordance with the present invention, NMR apparatus of the kind described is characterized in that the RF receiving and generating coils are located in a reduced diameter section of the probe at its leading end; and in that at least some of the shim coils are located on a support surrounding the reduced diameter section of the probe.

We have realised that an important factor in the overall size of the apparatus is the diameter of the bore. Typically, each millimetre of saved bore space can equate to a significant radial decrease in the windings making up a coil defining the magnetic field generator. Further, we have realised that although the probe carries many conductors and control lines in conventional arrangements, typically up to 80 or even more, together with tuning circuits and power capacitors and thus needs the full width of the bore to accommodate these components, the components which need to be located adjacent the working volume require less radial space and thus can be accommodated within a reduced diameter section of the probe. This in turn releases a space radially outward of the reduced diameter section of the probe which can be used to accommodate shim coils. As a result, it is possible to accommodate the components of the apparatus into a smaller diameter bore with the advantages mentioned above.

Although the shim coils support could be separate from both the probe and the sample support, preferably the two are coupled, typically integrally formed. In the past, the sample support or “top tube” has merely served to support the sample but in this preferred aspect, it can also be used to support the or some of the shim coils and contain the power lines needed to couple the shim coils with a power supply.

In some examples, all the shim coils are provided on the shim support but in some cases, either the axial field shim coils or the radial field shim coils could be located within the reduced diameter section of the probe. This is a matter of design choice and has the advantage that some aspects of a conventional probe with a shim coil power supply could be used.

Typically, the sample support includes a tube and as in conventional arrangements, this may include a mechanism for rotating the sample within the working volume.

The magnetic field generator can take any conventional form and could include a permanent magnet but typically is defined by a superconducting coil of either low or high temperature superconductor. In these cases, the coil will be housed within a cryostat in a conventional manner.

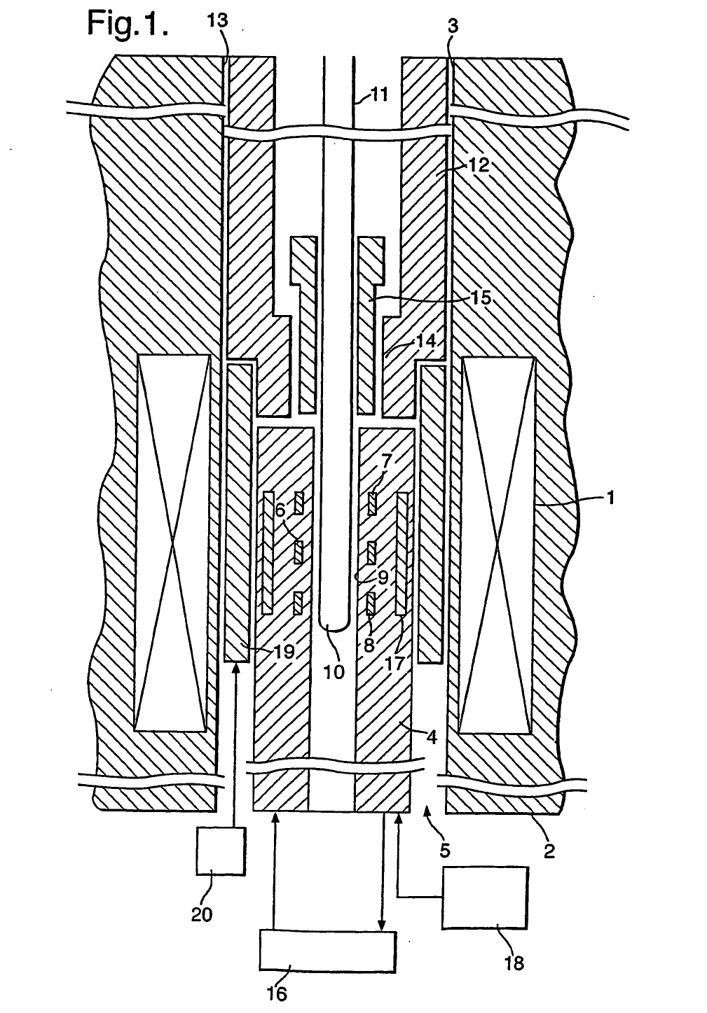

Some examples of apparatus according to the invention will now be described and contrasted with known apparatus with reference to the accompanying drawings, in which:—FIG. 1 is a schematic, longitudinal section through known NMR apparatus;

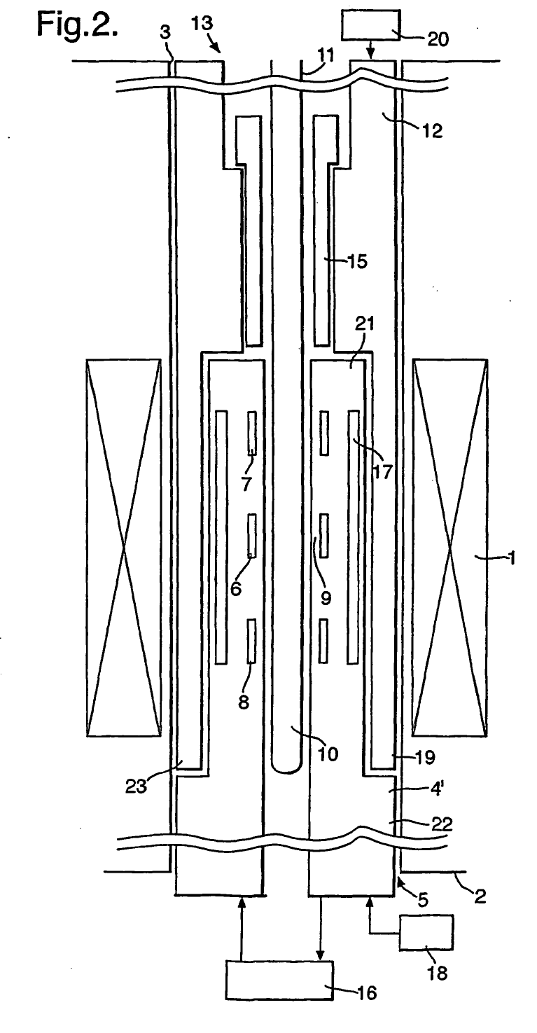

FIG. 2 is a view similar to FIG. 1 but of a first example of apparatus according to the invention; and,

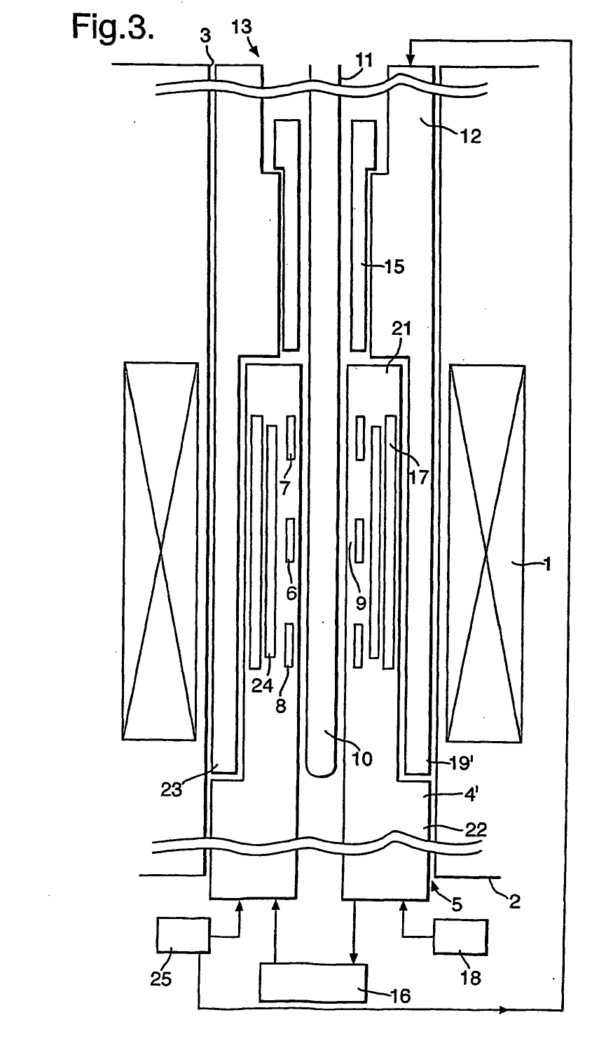

FIG. 3 is a view similar to FIG. 1 but of a second example of the invention.

The apparatus shown in FIG. 1 will be connected in use to conventional NMR processing components (not shown) and comprises a main magnetic field generator 1 constituted by a superconducting coil located within a cryostat 2. Typically, the coil 1 will be maintained at liquid cryogen, e.g. helium, temperatures. The cryostat 2 defines a room temperature bore 3 arranged vertically as shown in FIG. 1. A probe 4 is removably inserted into the bore 3 from its lower end 5, the probe mounting within it an RF generating coil 6 and RF receiving coils 7,8. The probe 4 is tubular and surrounds a space 9 defining a working volume within which a sample 10 is located in use. The sample 10 is contained within a tube 11 mounted to an outer, top tube 12 removably inserted through the top 13 of the bore 3. The top tube 12 has a reduced diameter section 14 which supports a spinner mechanism 15 to which the tube 11 is attached. The spinner 15 can be driven to rotate within the reduced diameter section 14 of the top tube 12 so as to rotate the tube 11 and hence the sample 10.

The RF generating coil 6 is coupled via wires (not shown) with RF electronics and power source 16 while the RF receiving coils 7,8 are also connected to the electronics 16 to enable received RF signals to be processed.

The probe 4 also supports gradient coils shown schematically at 17, these gradient coils being powered from a power source 18.

A set of shim coils 19 are arranged concentrically about the working volume 9 and are powered from a shim coil power source 20 through wires extending through the bottom opening 5 of the bore 3.

The top tube 12 and probe 4 can be removed from the bore and reinserted without having to purge the cryostat 2.

As explained above, the problem with this known arrangement is the wide diameter required for the bore 3 in order to accommodate all the components.

A first example of apparatus according to the invention is shown in FIG. 2 and components which are similar to those shown in FIG. 1 have been given the same reference numerals and will not be further described. As can be seen, in this case, the probe 4′ has a reduced diameter section 21 at its leading end surrounding the working volume 9. Within this reduced diameter section 21 are located the RF coils 6,7 and gradient coils 17. The more bulky components which need to be carried within the probe are located in the wider diameter section 22 of the probe.

In this example, the shim coils 19 are mounted on a support constituted by a tubular extension 23 of the top tube 12, the radial dimension of the tubular extension 23 being substantially equal to the difference in radial dimension of the small and large diameter sections 21,22 of the probe. Power from the shim coil source 20 is communicated to the shim coils 19 through the top tube 12.

As can be seen by comparing FIGS. 1 and 2, the components have been much more efficiently mounted so that a narrower bore 3 can be used. An example of the reduction which can be achieved is from a bore diameter of 54 mm to a bore diameter of 49 mm while achieving the same probe functionality. This will result in a significant reduction in the diameter of the magnet 1 and so the stored energy of the magnet will be significantly less than in the conventional design.

In the FIG. 2 example, the shim coil support 23 was integral with the remainder of the top tube 12. In an alternative design (not shown), the support 23 could be separate from the top tube 12 but power would still normally be supplied to the shim coils through the top 13 of the bore 3.

In the examples mentioned so far, the shim coils have been located in their entirety on the shim coil support 23. FIG. 3 illustrates a modification in which some of the shim coils 24 are located within the reduced diameter section 21 of the probe 4′. (Again, in FIG. 3, those components which are the same as in FIGS. 1 and 2 have been given the same reference numerals.) Thus, as can be seen in FIG. 3, some shim coils 24 are mounted within the reduced diameter section 21 of the probe. In one example, the axial shim coils are located in the probe and radial shim coils 19′ in the support 23. In another arrangement, this can be reversed. In addition, in each of these cases, the support 23 may be integrally formed with the top tube 12 (as shown) or separate from it.

Where some of the shim coils are mounted in the probe as shown in FIG. 3, an additional shim coil power source could be provided but in the preferred arrangement (FIG. 3), a single source 25 is used.

1. Apparatus for use in a NMR system, the apparatus comprising:
a magnetic field generator surrounding a bore, and generating a magnetic field in a working volume located in the bore;
a sample support removably insertable into a first end of the bore so as to locate a sample in the working region;
a probe carrying RF generating and receiving coils and be removably insertable into the other, second end of the bore so as to locate the RF coils adjacent the working volume; and
a set of shim coils located in the bore about the working volume and which cooperate with the magnetic field generator to create a magnetic field in the working volume of sufficient uniformity to perform a NMR experiment on a sample,
the RF receiving and generating coils being located in a reduced diameter section of the probe at its leading end, and
at least some of the shim coils being located on a support surrounding the reduced diameter section of the probe.

2. Apparatus according to claim 1, wherein the shim coil support is coupled, preferably integrally formed, with the sample support.

3. Apparatus according to claim 1 or claim 2, wherein the reduced diameter section of the probe includes other shim coils.

4. Apparatus according to claim 3, wherein the reduced diameter section of the probe includes axial field shim coils.

5. Apparatus according to claim 1, wherein the reduced diameter section of the probe includes radial field shim coils.

6. Apparatus according to claim 1, 2, or 5, wherein the reduced diameter section of the probe terminates at a wider diameter section, the wider diameter section substantially filling the bore cross-section.

7. Apparatus according to claim 1, wherein all the shim coils are located axially spaced from the wider diameter section of the probe.

8. Apparatus according to claim 1, wherein the reduced diameter section of the probe supports one or more gradient coils.

9. Apparatus according to claim 1, wherein the sample support comprises a tube.

10. Apparatus according to claim 1, wherein the sample support includes a mechanism for rotating the sample within the working volume.

11. Apparatus according to claim 1, wherein the magnetic field generator comprises a superconducting coil.
